(19) United States
(12) Patent Application Publication
(10) Pub. No.: US 2022/0147903 A1
(43) Pub. Date: May 12, 2022

(54) PLATFORM FOR SKILL DATA MANAGEMENT

(71) Applicant: Macnica Americas, Inc., Solana Beach, CA (US)

(72) Inventors: Daichi Yoshikawa, Campbell, CA (US); Daisuke Nishimura, Cupertino, CA (US)

(21) Appl. No.: 17/522,784

(22) Filed: Nov. 9, 2021

Related U.S. Application Data
(60) Provisional application No. 63/111,547, filed on Nov. 9, 2020.
(60) Provisional application No. 63/111,551, filed on Nov. 9, 2020.
(60) Provisional application No. 63/223,489, filed on Jul. 19, 2021.

(51) Int. Cl. G06Q 10/06; G06F 16/953; G06F 16/901

(52) U.S. Cl. CPC G06Q 10/063112; G06F 16/953; G06Q 10/063118; G06F 16/9024; G06F 16/9027

(57) ABSTRACT

A platform for skill data management includes a search engine with recommendation algorithm to search for experts, a platform to rate advisors, report hidden contributions, and endorse skills for other users, a function to evaluate work efficiency and advisor's help quantitatively, and audio/video chat functionality that is optimized for a short and verbal conversation.

### REFERENCE TO RELATED APPLICATIONS

This patent application claims the benefit of each of the following U.S. Provisional patent applications:
U.S. Prov. Ser. No. 63/111,547 filed Nov. 9, 2020;
U.S. Prov. Ser. No. 63/111,551 filed Nov. 9, 2020; and
U.S. Prov. Ser. No. 63/223,489 filed Jul. 19, 2021.

This application incorporates by reference each of the above-identified three patent applications. This patent application is related to and incorporates by reference U.S. patent application Ser. No. 17/522,768, filed on Nov. 9, 2021. The above-referenced provisional and non-provisional patent applications are collectively referenced herein as “the commonly assigned incorporated applications.”

### FIELD

This patent specification generally relates to skill data management. More particularly this specification relates to platforms for managing and using skill data obtaining from a population of individuals.

### BACKGROUND

Companies are increasingly facing a “digital skill gap” of employees. Some estimate that more than half of all employees will require significant reskilling by 2022. The gap is inevitable because many kinds of markets are driven and accelerated by digital technologies, and people who own some expertise in a specific domain need to catch up to new demands in the markets. To address the digital skill gap, companies are trying to more fully utilize existing resources, for example, by training/educating employees and/or re-assigning employees. Companies are also trying to address the digital skill gap by looking outside, for example, by finding and hiring new employees with required skill sets, or outsourcing from a third party.

### SUMMARY

According to some embodiments, a method of bottom-up building and operating a computer-implemented platform that speeds up network operation and reduces data storage requirements, comprises: providing computer-stored skill data of experts as graphs that comprise nodes and edges related to respective skills and relationships of skills that reduce redundancy in skill identities and thereby reduce data storage requirements compared with tree structures of skill identities; in response to a network-transmitted inquiry from a user seeking expert advice regarding a skill set, carrying out computer-implemented, content-based and other filtering of said graphs and/or of skill maps related to the graphs to thereby identify a set of experts fitting the inquiry; establishing network communication between the user and an expert selected from said set of experts; computer-limiting said communication in duration and in timing based on factors including data stored in the platform regarding limitations on times and duration associated with the selected expert and concluding the communication according to said duration limitations, thereby reducing network load and speeding up network operation compared to operation without said limitations; computer-tracking and storing parameters of the communication including whether an issue associated with the inquiry was resolved, time-savings to the user associated with or resulting from the communication, and time investment by the expert in the communication and computer-quantifying and storing parameters related to benefits from communications between users and experts and time of experts related to the communications; and providing users with networked access to pre-stored answers by experts associated with respective experts and respective skill identities contained in said graphs of nodes and edges to thereby reduce network traffic and computer usage due to reduction of requests for direct communications with experts.

The method can further comprise one or more of the following features: (a) said providing of skill data of experts as graphs is configured for dynamic bottom-up updating of said graphs by adding or deleting skill identities and/or experts based at least in part to said communications between users and experts; (b) said filtering includes initial filtering by skill identity rather than identity of experts; (c) said computer-tracking and storing parameters comprises associating rewards to experts based at least in part to the nature and extent of their participation in said communications with users to thereby encourage experts to participate in providing advice to users; (d) said computer-limiting of communication in duration and timing comprises limiting a communication between a user and an expert to a time slot less than one hour, automatically announcing that the time slot is about to expire, and automatically terminating the communication at the expiration of the time slot, thereby reducing network load by precluding non-essential extension of communications; (e) said providing of access to pre-stored answers by experts comprises associating individual experts with respective sets of said pre-stored answers; (f) said providing of access to pre-stored answers by experts comprises associating individual skill identities with respective sets of said pre-stored answers; (g) said graphs comprise nodes associated with respective skills that are identified by name as well as aliases and abbreviations thereof without duplication of names, aliases or abbreviations, thereby reducing memory requirements for storing identities of skills compared with storing tree structures of skill identities, while facilitating search for skills identified by an alias of an abbreviation of a skill name; and (i) said filtering includes computer-implemented dynamic rating of experts based on past user-expert communications.

According to some embodiments, a method of bottom-up, computer-implemented operation of a system for providing expert advice to users, comprises: computer-storing skill data as graphs that comprise nodes and edges related to respective sets of related skills and relationships of the skills using less data storage compared with tree structures of the skills and relationships; transmitting via a network a request from a user for expert advice regarding a skill or a skill set; computer-processing the request based at least in part of said skill data stored as said graphs of nodes and edges to filter said graphs and thereby select a skill or a skill set that fits the request; further computer-implemented filtering to select an expert associated with the selected skill or skill sets based on parameters including expert availability and past interactions of experts and users; establishing network communication between the user and the selected expert; computer-limiting said communication in duration and limiting timing of the communication, thereby reducing network load and speeding up network operation compared to network operation without said limitations; computer-tracking and storing assessment data related to the communication including whether and how the request was resolved, time-savings to the user associated with or resulting from the communication, and time spent by the expert in the communication, and storing data regarding assessments of and benefits from communications between users and experts and time spent by experts related to the communications; and providing users with networked access to pre-stored answers by experts associated with respective experts and respective skill identities contained in said graphs of nodes and edges to thereby reduce network traffic and computer usage due to reduction of requests for and direct communications with experts.

According to some embodiments, the method described in the immediately preceding paragraph can further comprise one of more of the following features: (a) said providing of skill data of experts as graphs comprises dynamic bottom-up updating of said graphs by adding or deleting skill and/or expert identities based at least in part on said communications between users and experts; (b) said filtering includes initial filtering by skill identity rather than identity of experts; (c) said computer-tracking comprises associating rewards to experts based at least in part to the nature and extent of their participation in communications with users to thereby encourage experts to participate in providing advice to users; (d) said computer-limiting of communication in duration and timing comprises limiting a communication between a user and an expert to a time slot less than one-half hour, automatically announcing that the time slot is about to expire, and automatically terminating the communication at the expiration of the time slot, thereby reducing network load by precluding non-essential extension of communications; (e) said graphs comprise nodes associated with respective skills that are identified by name as well as aliases and abbreviations thereof without duplication of names, aliases or abbreviations, thereby reducing memory requirements for storing identities of skills compared with storing tree structures of skill identities, while facilitating search for skills identified by an alias of an abbreviation of a skill name; and (f) said filtering includes computer-implemented dynamic rating of experts based on past user-expert communications.

According to some embodiments, a system for bottom-up, computer-implemented provision of expert advice to users comprises: a computer-implemented facility storing skill data as graphs of nodes and edges related to respective sets of related skills and relationships of the skills, thereby reducing data storage computer memory requirements compared with storing tree structures of the skills and relationships; a skill-selecting, computer-implemented search and filtering facility configured to respond to user requests for expert advice by selecting respective skills or skill sets in said graphs fitting the respective requests; a user-selecting, computer-implemented facility configured to select respective experts associated with the respective selected skills or skill sets based on expert availability and user inputs related to past requests for expert advice; computer-processing the request based at least in part of said skill data stored as said graphs of nodes and edges to filter said graphs and thereby select a skill or a skill set that fits the request; further computer-implemented filtering to select an expert associated with the selected skill or skill sets based on parameters including pre-stored data regarding expert availability and past interactions of experts and users; a network facility configured to provide communication between users and selected experts related to said requests; a communication-limiting facility configured to computer-limit said communications in duration and in timing of the communications, thereby reducing network load and speeding up network operation compared to network operation without said limitations; a tracking facility configured to computer-track said user-expert communication and extract and store assessments related thereto including regarding resolutions of the requests, time-savings to the users associated with or resulting from the communications, and time spent by the experts in the communications, and storing data regarding assessments of and benefits from said communications and time spent by experts related to the communications; and a networked access facility providing users with pre-stored answers by experts associated with respective experts and respective skills identified in said graphs of nodes and edges to thereby reduce network traffic and computer usage due to reduction of requests for and direct communications with experts.

According to some embodiments, the system can further comprise one of more of the following: (a) a facility configured to dynamically, bottom-up update said graphs by adding or deleting skill and/or expert identities based at least in part on said communications between users and experts; (b) a reward facility configured to track said communications and to assign rewards to experts based at least in part to the nature and extent of their participation in said communications with users to thereby encourage experts to participate in advising users; and (c) said computer-implemented facility storing skill data as graphs of nodes and edges stores nodes associated with respective skills that are identified by name as well as aliases and abbreviations thereof without duplication of names, aliases or abbreviations, thereby reducing memory requirements compared with storing tree structures of skill identities, while facilitating search for skills identified by an alias of an abbreviation of a skill name.

As used herein, the grammatical conjunctions “and”, “or” and “and/or” are all intended to indicate that one or more of the cases, object or subjects they connect may occur or be present. In this way, as used herein the term “or” in all cases indicates an “inclusive or” meaning rather than an “exclusive or” meaning.

### BRIEF DESCRIPTION OF THE DRAWINGS

To further clarify the above and other advantages and features of the subject matter of this patent specification, specific examples of embodiments thereof are illustrated in the appended drawings. It should be appreciated that elements or components illustrated in one figure can be used in place of comparable or similar elements or components illustrated in another, and that these drawings depict only illustrative embodiments and are therefore not to be considered limiting of the scope of this patent specification or the appended claims. The subject matter hereof will be described and explained with additional specificity and detail through the use of the accompanying drawings in which:

FIG. 1. is a diagram illustrating system architecture for a platform configured to managing skill data, according to some embodiments;

FIG. 2 is a diagram illustrating how a user can view skill data of found experts, according to some embodiments;

FIGS. 3A and 3B are diagrams illustrating examples of item-based filtering, according to some embodiments;

FIG. 4 is a diagram showing an example of hybrid filtering, according to some embodiments;

FIG. 5 is a diagram illustrating a user interface configured to offer a skill name suggestion, according to some embodiments;

FIG. 6 is a diagram illustrating a workflow from searching for experts to rating, according to some embodiments;

FIG. 7 is a graphical display of a user's accumulated rating data in saved hours as and advice seeker and advisor, according to some embodiments;

FIG. 8 is a graphical display of a user's accumulated rating data in spent hours as an advisor, according to some embodiments;

FIGS. 9 and 10 are plots illustrating reduction of repetitive questions and maintenance costs due to an individual wiki, according to some embodiments;

FIGS. 11 and 12 are graphical user interface of learning content recommended by other users, according to some embodiments;

FIG. 13 is a diagram illustrating an example of estimating available time slots with an integrated calendar, according to some embodiments;

FIG. 14 is a block diagram illustrating built-in video/audio chat functionality, according to some embodiments; and

FIGS. 15A-15I are examples of a screens from a graphical user interface for a platform for skill data management, according to some embodiments.

### DETAILED DESCRIPTION

A detailed description of examples of preferred embodiments is provided below. While several embodiments are described, it should be understood that the new subject matter described in this patent specification is not limited to any one embodiment or combination of embodiments described herein, but instead encompasses numerous alternatives, modifications, and equivalents. In addition, while numerous specific details are set forth in the following description in order to provide a thorough understanding, some embodiments can be practiced without some or all of these details. Moreover, for the purpose of clarity, certain technical material that is known in the related art has not been described in detail in order to avoid unnecessarily obscuring the new subject matter described herein. It should be clear that individual features of one or several of the specific embodiments described herein can be used in combination with features of other described embodiments or with other features. Further, like reference numbers and designations in the various drawings indicate like elements.

According to some embodiments techniques are described for tracking and updating the skill data of employees and other individuals. The described techniques facilitate more fully utilizing existing human resources within an organization as well as finding and/or hiring individuals and/or outsourcing tasks to outside individuals. Skill data is difficult to maintain by top-down approach, because it's almost impossible to grasp all possible skills and execute due diligence for each employee. According to some embodiments, the company instead takes a bottom-up approach to handle skill data in a sustainable way.

According to some embodiments, techniques for managing skill data are described. Techniques to extract skill data as reliably/objectively as possible, to apply a graph data structure to skill data for efficient data management, to suppress duplicate skill data to reduce data storage consumption, to cluster/group multiple skill data to see an overview of large skill data map for analysis, and conversion of skill data into productivity and a smart filter used for thorough analysis of skill data.

According to some embodiments, a platform is described which provides a sustainable ecosystem for tracking, updating and maintaining skill data of employees and/or other individuals. With the platform, employees or other individuals may initialize their skill data, update skill data, endorse other's skill data to keep updating and maintaining skill data.

According to some embodiments, the described platform provides employees or other individuals with day-to-day benefits brought by managed skill data. It includes a search engine, with which users can search for experts who are familiar with what users would like to get advice on, a rating system which reveals how much each employee saved others by his/her advice and how efficiently each employee is working by properly asking experts for some advice, and a built-in video/audio chat system which is optimal for a short (e.g. about 30 mins) conversation, etc.

As used herein the term “skill” is interchangeable with “experience” or “familiarity.” That is, the term “skill” is not limited to the ability to do something professionally. The term may include expertise, familiarity, and knowledge. According to some embodiments, described systems and techniques do not accept skills which the user only claims to possess, but are not also accompanied with some industrial and/or academic experiences.

As used herein the term “user” refers to a user of a service for managing skill data. The “service” may be a desktop application, SaaS, or PaaS, etc.

As used herein, the term “edit” refers to actions such as adding, deleting, coping, pasting, and/or modifying something.

When a skill and/or experience: (a) has a parent-child relationship with; (b) is similar to; (c) is used for; or (d) is applied to other skill(s)/experience(s), it is said that the skill and/or experience has a “relevance” to other skill(s) and/or experience(s).

As used herein the terms “skill map” and “skill data map” refer to a set of skill data of an individual user or a group.

As used herein the terms “expert” and “advisor” refer to a user who possesses a skill, expertise, familiarity and/or knowledge in a specific domain. An example is an application with which a user searches for experts by a skill name. Experts will generally register their skills to the database of the platform.

As used herein, the term “company” can refer to an organization, school, university, college, governmental facility, institute and/or community.

As used herein, the term “employee” can refer to a student, officer, volunteer, or other person who belongs to a certain organization or company.

As used herein, the term “skill graph” refers to skill data managed as a graph data structure.

As used herein, the term “skill tree” refers to skill data managed as a directory tree structure.

As used herein, the term “advice seeker” refers to a user who would like to be advised, helped, supported and/or received aid from experts and/or advisors.

As used herein, the term “advisor” refers to a user who advises, helps, supports and/or gives aid to an advice seeker.

As used herein, the term “help” us synonymous with advise, support, coach, hint and/or inspire. The term also includes introducing resources and/or materials and/or introduce another advisor.

As used herein, the term “employee recognition” refers to acknowledgement of an employees' contribution, and the terms is used interchangeably with “personnel evaluation.”

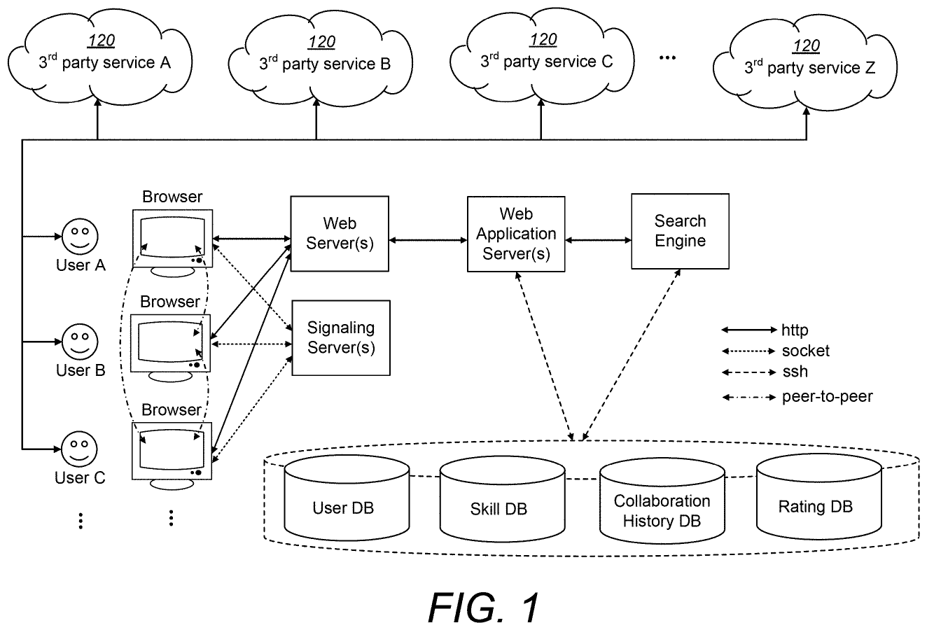

FIG. 1. is a diagram illustrating system architecture for a platform configured to managing skill data, according to some embodiments. The platform is a system consisting of several modules. Users interact with the platform through browsers and http requests. The web server may also work as a proxy server and/or load balancer. A reverse proxy server may be installed between the web server and web application server. Network communication may be all or partially encrypted. The web application server is configured to pass the request to the search engine if the search engine is used, otherwise it may access the database (DB), process the request and return the result to the web server. Generally, the search engine works asynchronously because it handles complicated processes which require high computational power. It accesses the DB if needed. DB contains at least data about user profiles, skills, collaboration histories, and ratings. These data may be stored in separate DBs or one DB may contain all of these. In addition to a general RDBS (Relational Database System) such as MySQL, Postgresql DB, SQLite, or Maria DB, NoSQL DB such as mongoDB, or Graph DB such as Neo4j can be used as DB.

The user data may contain user name, email, password, title, high-level categories of user's role (eg. “Sales”, “Marketing”, “Legal”, “Software Engineer”, “Mechanical Engineer”, “Electrical Engineer”, etc.). Skill data may contain a skill name, “Who has what skills?”, etc., collaboration history contains data such as search histories, video/audio/text chat history of employees, etc., and rating data contains records of rating by and/or for an employee, etc.

A user may have a short video/audio/text chat with other(s) by peer-to-peer (P2P) communication. For P2P communication, the signaling server may be used. Though not depicted, servers which may be required for remote communication, such as STUN (Session Traversal Utilities for NAT) server, TURN (Traversal Using Relay around NAT) server, and/or ICE (Interactive Connectivity Establishment) server, etc. may be used together.

According to some embodiments, some system modules shown in FIG. 1 may be partially replaced with third party services, tools, and/or applications which have similar or equivalent functionalities. For example, the signaling server, which is used for a P2P communication, can be replaced with a third party service, such as VoxImplant (https://voximplant.com/), Twilio (https://www.twilio.com/), etc.

The platform may be used with the workflow as follows. (1) Users create their accounts and register skill data based on their past/current work experiences. Instead of creating accounts, OAuth/Single Sign-on (SSO) may be used. (2) When a user encounters some issue and needs help, the user searches experts by skill name relevant to the issue or user name. Here, some filters may be used (for example, experience periods >3 years, etc.). (3) The system searches experts based on the user's request. Here, a recommendation algorithm may be used to sort and prioritize the found experts. It may use skill data, collaboration history, and rating data for recommendation algorithms. (4) The user sees the found (sorted, and prioritized) experts. Availability of experts may be also shown. The availability of experts is detected by integrating some other services with the platform. For example, by integrating a calendar with the platform, the system can detect available time of experts, and also can let users know suitable time slots. (5) The user selects one of the experts, and asks a question with whatever communication tool the user likes. A built-in video/audio/text chat may be used. Or any communication tools such as Slack, Microsoft Teams, Skype, E-mail, Phone call, Zoom, etc. may be used instead. (6) The user rates the expert who gave him/her an answer/advice/hint. For example, the user would report saved hours by the help. The expert who helped may be also able to report how he helped. For example, the expert would report spent hours to help the user. (7) At the same time, the user may endorse skill(s) to the expert, especially when the user is impressed by the expertise. (8) All users can see the accumulated records of ratings and endorsements. How much people are working efficiently and how much experts are contributing to the company are illustrated quantitatively. This may be used as part of the organization's employee recognition program.

Although conventional services, products, and tools are known which allow users to add/delete/update skill data and manage all user skill data in the centralized DB, they don't generally have a mechanism to encourage users to keep updating/maintaining skill data while providing users with day-to-day benefits.

Conventional solutions regarding skill data management are often implemented as follows. (1) Skills are self-reported by employees per quarter or half a year or annually. (2) Skills are predefined by some specific department (for example, the Human Resources) or external consulting firm or resources (for example, a skill database provided by some facility or institute, etc.), and employees would select relevant ones. (3) Pre-defined skills are seldom updated or maintained. And (4) skill data is only used for a personnel evaluation purpose. Such solutions can cause issues, including the following. (1) Unreliability of skill data and lack of functions to improve it. The skill data is edited just based on a subjective decision of each employee and not certificated/endorsed, that is, stored skill data tends to be unreliable. (2) Problems associated with a top-down approach. Since it is managed by a top-down approach, some important skills are not covered by the predefined skills and people who have important skills may be overlooked. For example, though well-known or general skills such as “Database” may be predefined, but skills used for the company's unique product may not be covered by the top-down approach. (3) Lack of mechanism for sustainable skill data management. Even if employees master new skills, unless the skills are newly defined in the system, employees can't report these. As a result, managed skill data tends to be obsolete. (4) Lack of day-to-day benefits for employees even though skill data management costs for employees. Since there's not a clear incentive to do it, employees don't spend enough time to update/maintain skill data.

Searching Experts with Recommendation Algorithm. According to some embodiments, a user can search other users not only by name but also skill name. For example, if the user encounters an issue regarding Python (one of the programming languages) and would like to ask a technical question about it, the user can search for experts working in the same company and familiar with Python by inputting “Python” in the form. According to some embodiments, multiple skill names can be specified at the same time. The skill may be company specific, that is, a user can search experts familiar with a product which is confidentially developed in the company.

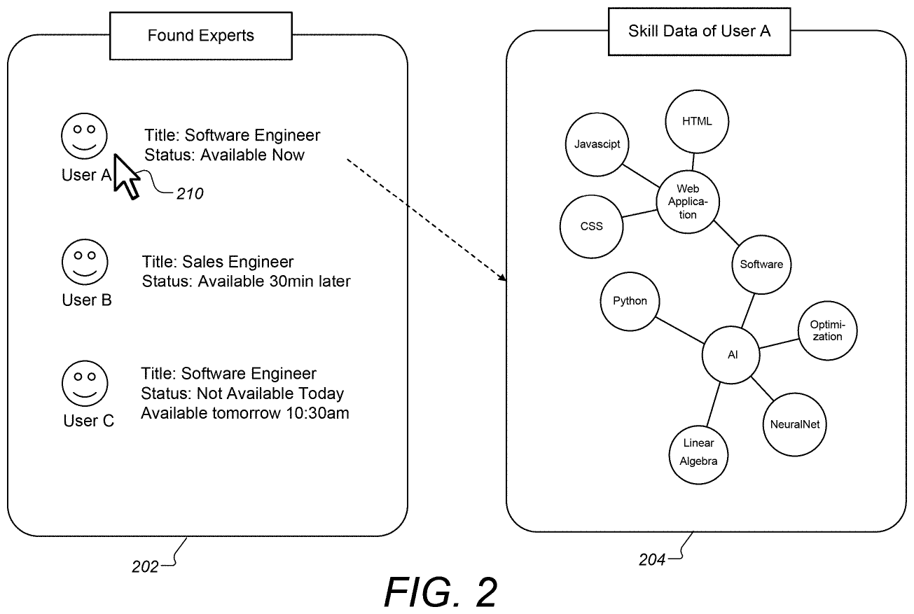

FIG. 2 is a diagram illustrating how a user can view skill data of found experts, according to some embodiments. As shown in FIG. 2, the user sees found experts as the search result with not only the basic info (window 202) of each expert like name and title, but also a skill graph of each expert (window 204). The graph is interactive and the user may see the detailed info of each skill, such as experience of years, type of experience (industrial, academic, or home project, etc.), etc. In the example of FIG. 2, the users' pointer 210 is clicked on or hovers over the User A search result and the skill graph of that result is shown, as in window 204.

The search results may include experts whose skills are matched by a fuzzy match and/or case insensitive match. Aliases and abbreviations may also be considered, that is, if the user searches “AI”, users who register “Artificial Intelligence” instead of “AI” as their expertises, are also listed as the search results. Those aliases and abbreviations may be stored in the skill DB (shown in FIG. 1).

The results may be sorted by simple criteria, or by a recommender system, and these are described infra. Users may choose a sorting algorithm to use and results may be sorted immediately. Results sorted by each criterion and/or the recommender system may be pre-calculated in a server side and cached in a client side (for example, in a memory of the user's computer). Or results sorted by each criterion may be calculated in the client side.

According to some embodiments, a user may configure the maximum number of advice per day/week/month. If the user has already advised others more than that number, the user may not be shown in the search result, or shown but with an indicator that he has already advised others too much in a day/week/month and would like to focus on his tasks.

Sorting Experts by Simple Criteria. Simple criteria of sorting can be configured as follows, and these may be used solely or together. In case a combination of criteria is used, the order of the criteria may be customized by users. (1) Exact match and fuzzy match. Experts, whose skills cover all the searched skills and all skills are relevant to each other (all skills represented in a graph are joined to each other somehow), come first. And then experts, whose skills cover all the searched skills but some skills are likely to be irrelevant to some searched skills (assuming that skills are represented in a graph, some searched skills do not have a path to reach out to some other searched skills), come next. Among fuzzy match results, the less fuzzy experts' skills exist, the more they are prioritized. (2) The Same role category. Experts whose role category is the same as the users, come first. For example, if the user's role category is “Software Engineer”, experts whose role category is “Software Engineer” come first and experts whose role category is “Sales” come later. (3) Favorite users. Experts registered as “favorite experts” by the user come first. (4) Proximity of belonging. Experts in the same team the user belongs to come first. Experts in different teams, but in the same department/division may come next. (5) Availability of experts. Experts who are available now, that is, who don't have any schedules now, come first. Schedules may be detected by a built-in calendar and/or external calendar services/tools integrated to the platform.

Sorting Experts by Recommender System. According to some embodiments, the recommender system is configured to sort and filter found experts based on data, such as the user's role category (e.g., Software Engineer, Sales, Marketing), skills, collaboration histories (see FIG. 1), rating data and the experts roles, skills, collaboration histories, etc.

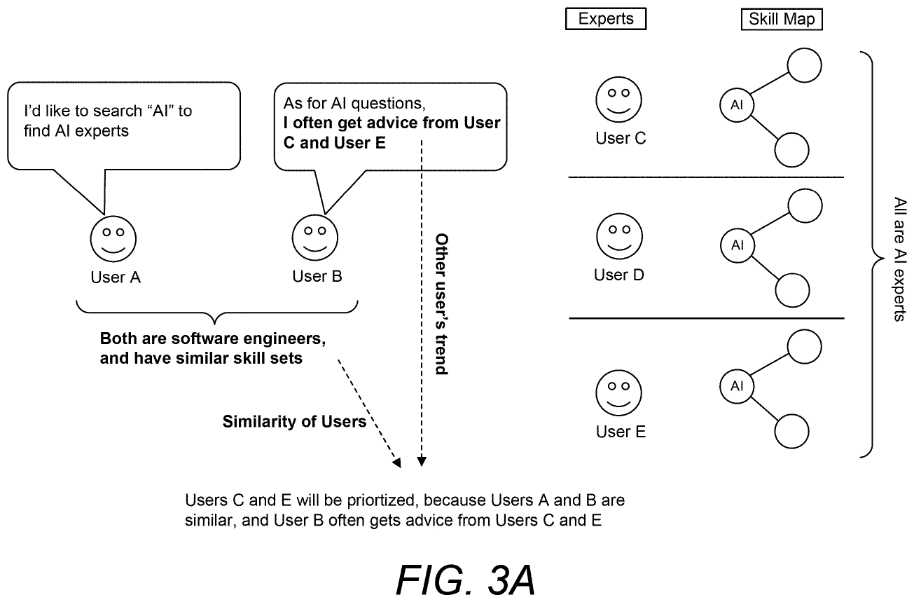

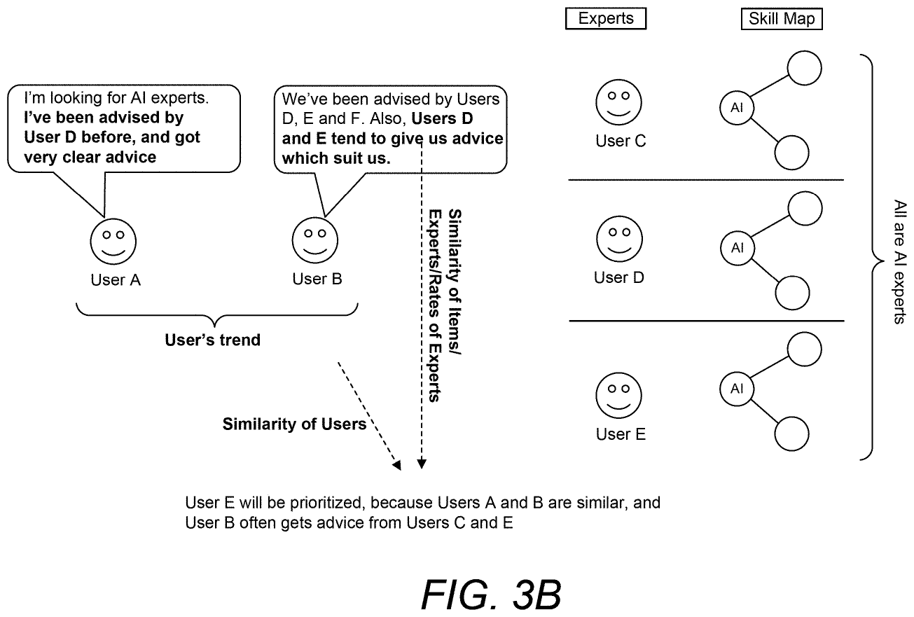

FIGS. 3A and 3B are diagrams illustrating examples of item-based filtering, according to some embodiments. A number of recommender systems may be used for the platform. Regarding the similarity which appears below, an euclidean distance, pearson correlation, cosine similarity, machine learning algorithm (e.g. k-means, neural networks (more specifically, deep learning, recurrent neural networks, long-short term memory networks/LSTM, etc.)), or bayesian inference/estimate, etc. may be used to calculate it. According to some embodiments, dimensionality reduction techniques such as a Principal Component Analysis (PCA), Linear-Discriminant Analysis (LDA), Singular Value Decomposition (SVD), feature importance derived from random forest, or t-Distributed Stochastic Neighbor Embedding (t-SNE) etc. may be used to reduce dimensions of variables. According to some embodiments, the recommender systems can include the following. (1) User-based filtering (see FIG. 3A). Assuming that experts who have similar skill-sets and career backgrounds could give better answers to the user, experts are sorted by the similarity of the skills (and roles) of the user and experts. (2) Inverse user-based filtering. Assuming that experts who have very different skill-set and career backgrounds could give better answers to the user, experts are sorted by the inverse of the similarity of the skills (and roles) of the user and experts. (3) Item-based filtering/Rate/“Saved hours”-based filtering (see FIG. 3B), and also see section 3.3 regarding rating and saved hours). Assuming that the experts who saved more hours for users similar to the user, could give better answers to the user, experts are sorted by the average/total saved hours rated by users who are similar to the user. Here, similar users may mean ones whose skill sets are similar to the user and/or have similar search histories, and/or have similar rating histories. (4) Content-based filtering. A user specifies multiple criteria of experts such as required length of each skill's experience, role category (Software Engineer, Sales, etc.), flag indicating whether experts must be available now or not, required total length of time spent to help others in the past 1 month, etc.

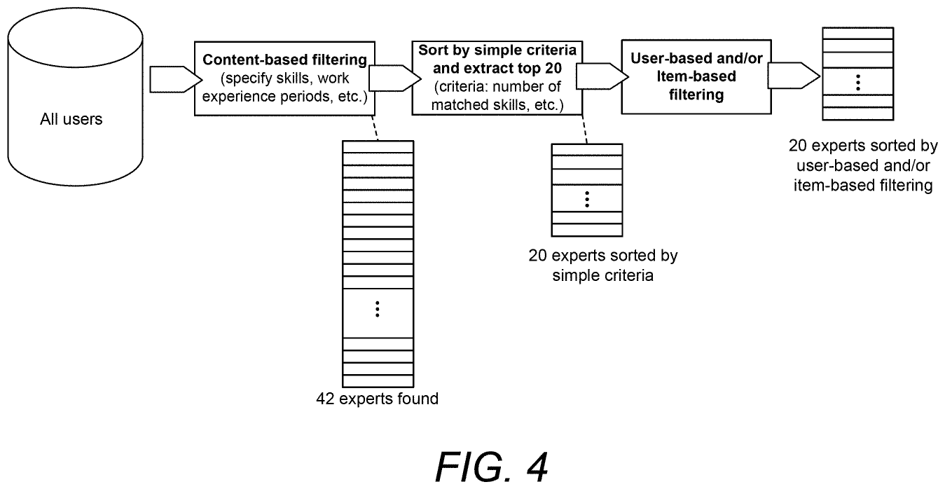

FIG. 4 is a diagram showing an example of hybrid filtering, according to some embodiments. In particular, hybrid filtering using a combination of (1) through (4) above may be used. For example, the recommender system sorts experts by content-based filtering first, extracts top N experts from the sorted result (eg. N=20), and then sorts the N experts by user-based filtering or item-based filtering (see FIG. 4).

In addition to the search results derived from the above functions, an additional search result which may still use the above functions but is more focused on the workload balance of advisors may be also shown to the user. The DB in the platform stores data of the monthly/weekly/daily help counts (total number of helps each user made for others in a month/week/day), and the recommender system may show experts which have lower help counts as priority. For example, Expert A, who has helped others only one time in this week, is prioritized more than Expert B, who has similar skill sets and collaboration histories, etc., but has already helped others times in the same week.

Recently, people have a lot of opportunities to get a variety of skills not only at work, but also after work and/or on weekends thanks to the internet, online-schools and classes, etc. Also, people working at relatively large companies can't know every single employee and generally have incomplete knowledge about the company's past projects/products. In such a situation, even if the company owns experts in some domain, employees struggle with finding internal experts, and sometimes may unnecessarily/redundantly ask for help from external experts (and it costs). This may be because conventional solutions (for example, collaborative tools such as Microsoft Teams, Slack, etc.) only provide functions to search other employees by name. Usually the company has a DB of all employees (which may include contract people, external board members/advisors, etc.), but employee's data doesn't contain skill data.

Since the platform described in this patent specification has a skill DB which associates employees with skills, users can search experts by skill name even though they don't know who they are. As a result, users could have more opportunities to get help from co-workers and avoid paying for external experts or redundantly hire another expert, and co-workers could have more opportunities to contribute to the company.

Furthermore, users can pick an expert who seems most suitable (here, suitable expert means an expert who is likely to give the clearest answer to the user) by observing skill data and/or the recommender system. The skill data is a very useful clue to grasp the depth of expertise and background of each expert. For example, if a user has a question regarding a recent trend of “Robotics”, the user may search experts in “Robotics”, the user will pick experts who have skills like “Marketing” and/or “Business Development” joined to “Robotics”, rather than ones who have skills like “Electrical Circuit” or “Quality Control”. The recommender system helps users find proper experts even if it's difficult to decide which experts are proper by themselves.

According to some embodiments, search results may be concentrated on a small group of users who help others a lot, but this issue may be avoided or minimized by additionally showing experts who are prioritized due to the less number of contributions. In short, the embodiments described in this section can improve employees' work efficiency by enabling them to find internal experts.

Sorting Experts by Heuristic Algorithm. According to some embodiments, a user can search other users not only by name but also skill name(s). The search engine may work with/without a recommender system, and work with/without heuristic algorithm(s). It may consider the following as variables. Here, “edge” is the one in skill graph data. (1) Text similarity of skill name, which may be calculated by trigram algorithm(s), cosine similarity, word2vec (a technique to represent word to an array of number(s)), variational autoencoder, and/or a combination of these, etc. (2) Text similarity of alias of the skill, which is calculated similarly to (1). (3) Attributes associated with the skill and/or its aliases, such as the period of its experience, indicator of how recently it is gained, etc. (4) The number of edges connected to the searched skill(s), because it may indicate how widely it can be used for a variety of applications. (5) The number of edges among searched skills (if the search input contains multiple skill names). (6) Attributes associated with the searched skill's edges.

With the above variables, experts may be sorted by the score calculated as below.

score=f(s,sₐ,P_{S},N_{S},N_{CS},Pₑ)

where s, sₐ, P_{S}, N_{S}, N_{CS}, Pₑ correspond to the above (1), (2), . . . , (6) respectively, and f( . . . ) may be a linear/non-linear function.

The heuristic algorithm can return the response faster than complicated recommender systems. Also, it would work even if not enough data required by recommender systems has been collected yet, in other words, it can solve a “cold start problem”.

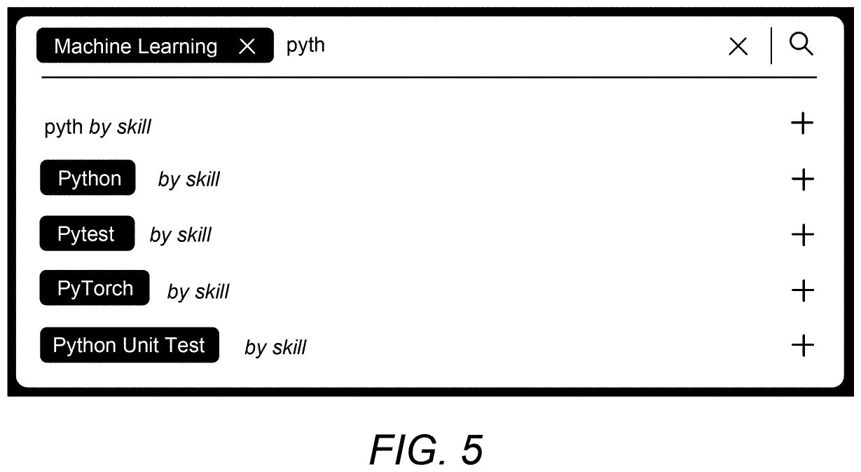

Input Suggestions of Skill Name. According to some embodiments, users have multiple opportunities to type skill name(s) in some input form to search experts by skills, or add skill data to the user's skill graph, etc. FIG. 5 is a diagram illustrating a user interface configured to offer a skill name suggestion. In the example shown, the user has input is “pyth.” According to some embodiments, the suggestions may be derived from the following factors. (1) Text similarity of skill name. For example, if the input is “pyth”, then “Python”, “Python 3”, and “Pytest”, etc. may be suggested. (2) Text similarity of alias skill name. For example, if “AI” is registered as an alias of “Machine Learning”, and the input text is “machine lea”, “AI” may be also suggested to users in addition to “Machine Learning”. (3) Past search history of the user. For example, if the user searches “Python 3” frequently, “Python 3” may tend to be more prioritized than “Python”, “Pytest”, etc. (4) Past search history of other users who have similar skill sets. For example, if the other users have skill sets similar to the user who searched, and they often search “Python 3” rather than “Python”, “Python 3” may tend to be more prioritized than “Python”. (5) The user's skill graph. For example, if “Python 3” is registered to the users' skill graph but “Python” is not, “Python 3” may tend to be more/less prioritized than “Python”. (6) Tenant-wide skill edges/relevances. If 1000 users have registered “Python 3” as a relevant skill to “Machine Learning” and only 100 users have registered “Python” as a relevant skill to “Machine Learning” as well, “Python 3” would tend to be more prioritized than “Python” when users input “pyth” with “Machine Learning”. According to some embodiments, the suggestions may be shown with the number of users whose skill graphs contain it, and/or its alias names.

Generally speaking, skills can be described in many ways because of a letter case variation (Eg. Starting from capital case or not), presence or absence of hyphens/whitespaces/version (Eg. “Autoencoder” or “Auto-encoder” or “Auto encoder” or “Auto encoder Ver.1.0”), abbreviation (Eg. “MS Excel” or “Microsoft Excel”), and aliases (Eg. “Machine Learning” or “AI”), etc.

Since the function allows users to pick one of the variations, users will have less chances to insert redundant data records to databases. Also, data cleansing which is required for any data-driven approaches utilizing skill data, can be simplified and done faster, because skill names are collected in a unified way.

Rating and Endorsement Platform. According to some embodiments, an advice seeker can rate the help from an advisor. For example, suppose that the advice seeker A searched experts, chose an advisor, and actually had a call with the advisor by some remote communication tool, for example using Zoom. He might thank the advisor on the call verbally, but he could also rate the advisor with the platform. According to some embodiments, the Rating can be done on a web page within the platform, where all calls/chats histories (stored in collaboration history DB shown in FIG. 1) may be shown at the same time. Those histories may be automatically created if the built-in chat system or any other remote communication tools are integrated to the platform. If the remote communication tool the advice seeker and advisor used was not supported or they didn't use any communication tools (eg. face-to-face verbal communication), one or both of them may manually create a history corresponding to the communication one or both of them would like to rate.

According to some embodiments, the rating by an advice seeker can include the following attributes. (1) Saved weeks/days/hours. If he couldn't get the help, how much hours would he need to spend to solve the issue? This value is an estimated value. Also, it may be discretized into bins, such as class A (less than 1 week/day/hour), B (1-3 weeks/days/hours), C (3-8 weeks/days/hours), D (8+ hours). (2) Topic regarding advice. For example, if he asked a question about Python, this value will be Python (or may be more specific). Usually this value is associated with skill data. (3) Consequence of the help. Would be “Solved”, “Partially solved”, “Hint was given/Inspired”, “Introduced another advisor”, “Introduced good resources”, etc. This is decided from the advice seeker's perspective. (4) A tool used in communication. This can be a built-in chat system, or any remote communication tools such as Zoom, Microsoft Teams, Skype, Slack, Phone, E-mail, etc. If the external tool is integrated with the platform, it may be shown as a dropdown item. (5) Date.

According to some embodiments, the advice seeker could endorse skills to the advisor. For example, if he was impressed by the advisor's Python skill, he could endorse the skill “Python” for the advisor. The endorsed skill is stored in skill DB and associated with the advisor's skill. Skill DB manages “endorsed count” for each user, each skill. So in this case, the advisor's endorsed count regarding the skill “Python” is incremented.

According to some embodiments, the rating is determined not only by an advice seeker, but also by an advisor. However, the advisor's rate may have a different set of attributes as follows. (1) Spent days/hours/mins. Days/Hours/Mins he spent to help the advice seeker. It contains time spent for all kinds of advisor's activities to help the advice seeker. For example, if he had 1 hour call with her to help but also spent 1 hour to investigate some resources to make sure the advice is really correct before the call, this value is 2 hours. As well as the saved hours of advice seeker, this value may be discretized. (2) Consequence of the help. Can be “Solved”, “Partially solved”, “Gave a hint/Inspired”, “Introduced another advisor”, “Introduced good resources”, etc. This is decided from the advisor's perspective. (3) A tool used through communication. This may be a built-in chat system, or any remote communication tools such as Zoom, Microsoft Teams, Skype, Slack, Phone, E-mail, etc. If the external tool is integrated with the platform, it may be shown as a dropdown item. (4) Date.

The rating data is accumulated in Collaboration DB (shown in FIG. 1), and the data may be used for recommender system's algorithms, a visualization of work efficiency and hidden contribution, or any further personnel evaluations of employees.

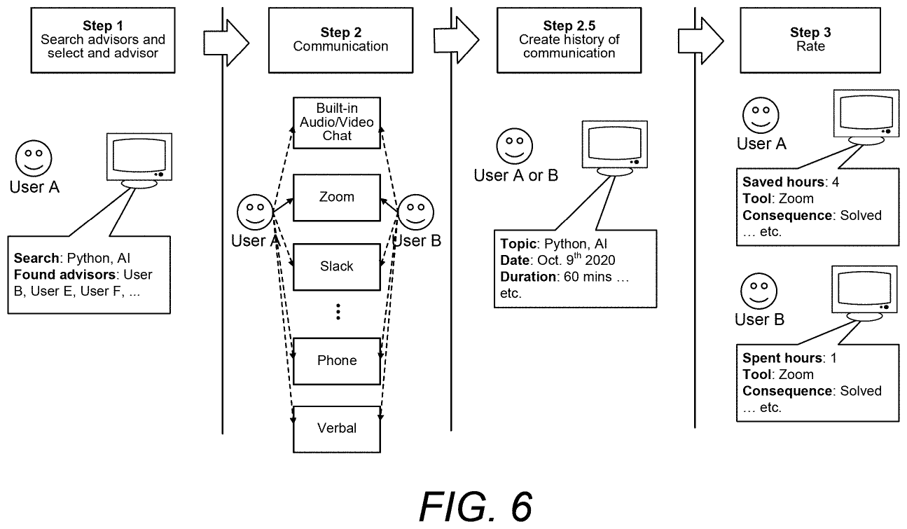

FIG. 6 is a diagram illustrating a workflow from searching for experts to rating, according to some embodiments. The described system can create a “win-win” relationship between advice seekers and advisors. It encourages employees to help each other by allowing advice seekers to appreciate advisors quantitatively, that is, advice seekers report saved hours and then the lost time of advisors and their hidden/invisible contributions get to be correctly evaluated and visualized. These were originally invisible, or have been ignored in personnel evaluations, or at least been evaluated very roughly and resulted in undervaluing advisors. Evaluating contributions and lost time of advisors which have been invisible could encourage employees (experts in specific domains) to help other people. Also, advisors can have opportunities to report the time they spent to help others explicitly. This could help advisors to be evaluated correctly in case of that advice seekers forgot to rate them.

Existing remote communication tools or skill management tools do not provide a user with a functionality to rate other users. Some software services for the Human Resource provide a function to evaluate employees, but the evaluation is done by manager-class people and not used frequently (generally per quarter or a half year). Here, in most cases, manager-class people don't know the details regarding how the team members are helping each other even if they know how each person is working individually. As a result, the following issues can be caused only with the existing solutions. (1) Advisors who spend a lot of time helping advice seekers tend to be undervalued, because they have less time to concentrate on their own tasks. (2) Advisors may start to avoid answering questions (spending time helping others), because it may just make them busy and undervalued. (3) Advice seekers may start to feel awkward asking questions to advisors, because they know it takes advisors' time but not enough appreciation. (4) The productivity of the company/department/team may decline because of less cooperation/collaboration/mutual help and support among people.

Some embodiments could be referred to as a foundation of an ecosystem for mutual help among employees. Importantly, the rating functionality is independent from a communication tool used by users. Only in case of that the built-in chat system is used, a rating page may be shown sequentially right after the communication and users may smoothly proceed the rating.

Visualization of Work Efficiency and Hidden Contribution. As described herein, advice seekers could rate the number of hours saved by advisors' help, and advisors could report time spent to help advice seekers. The embodiment illustrated in this section is one of the most beneficial usages of those data.

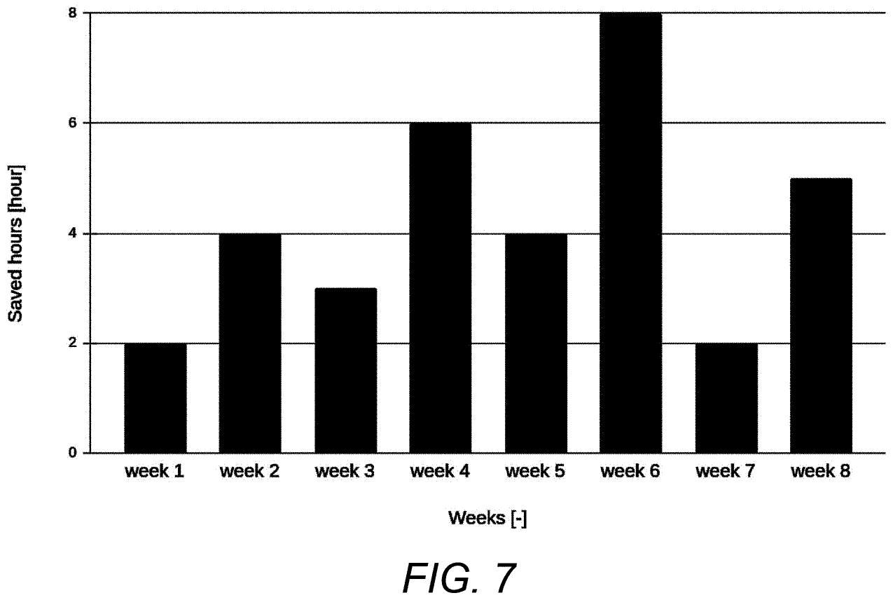

FIG. 7 is a graphical display of a user's accumulated rating data in saved hours as an advice seeker and advisor, according to some embodiments. Shown is an example of how a user can see his/her accumulated rating data as an advice seeker and advisor. Rating data as an advice seeker may be visualized as shown in FIG. 7, where x-axis and y-axis are weeks and total saved hours in each week respectively. Y-axis may be replaced with other attributes introduced supra. For example, y-axis may be the number of problems which was solved thanks to advisors in a week, etc.

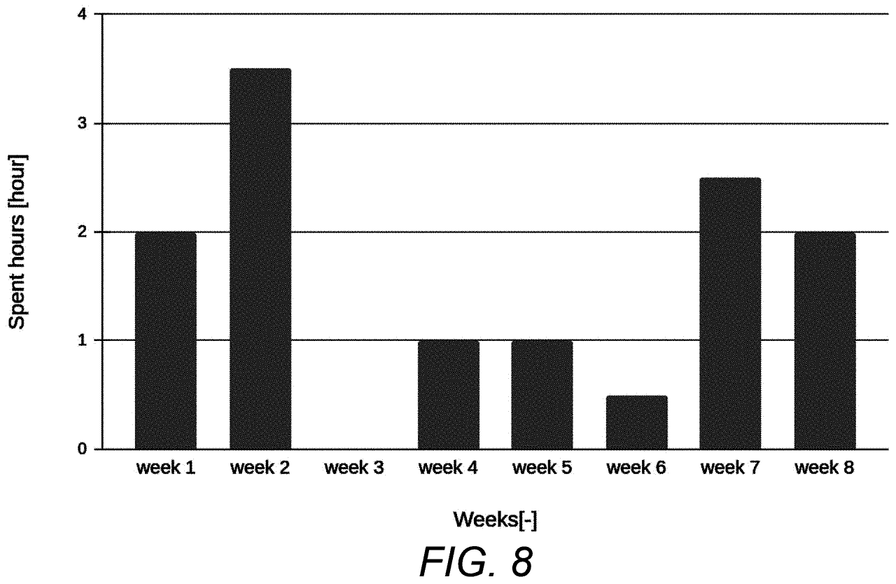

FIG. 8 is a graphical display of a user's accumulated rating data in spent hours as an advisor, according to some embodiments. In FIG. 8, the x-axis and y-axis are weeks and total spent hours to help others in each week respectively. According to some embodiments, the Y-axis may be replaced with other attributes introduced above. For example, y-axis may be the number of problems which the user solved as an advisor in a week.

According to some embodiments, the spent hours may be calibrated by the number of help events. Suppose that this expert A had 10 mins calls 10 times, and this expert B had 100 mins call just one time. In this case, it's reasonable to consider that expert A is more interrupted than expert B, because expert A had more chances to switch his mind. The calibration may be done by the following equation.

$${T}_{calibrated} = {\sum }_{i = 0}^{{N}_{help}} ( {t}_{i} + {b}_{i} )$$

where, T_{calibrated}, Nₕₑₗₚ, tᵢ, bᵢ are the calibrated total spent hours, the number of help the advisor did in a week, the hours spent for i-th help, and bias for i-th help, respectively. The bias corresponds to the time the advisor indirectly lost in order to help the advice seeker. It may be constant for all help, but may vary depending on how the help was done (for example, the communication was scheduled? or suddenly had an incoming call?, etc.).

The scale of each axis may be customizable. Also, filtering functions such as “do not show data with saved hours <30 mins” are available. Furthermore, statistical values regarding the data are also available, such as weekly average of saved hours, total saved hours in a month, the number of problems which was solved thanks to advisors in a month, or the number of problems which a user solved as an advisor, etc. These statistical values may be shown in the form of a table.

According to some embodiments, the system is configured to determine and display a quantitative evaluation of efficiency of each employee and an invisible/hidden/unclear contribution of each employee. Generally, a large part of personnel evaluations focus on the achievements of each employee, and missing a lot of “invisible/hidden” contributions of experts. For example, some senior engineers may spend a lot of time helping junior staff, but other senior engineers may not do so and just focus on their own tasks. However, both are evaluated almost only based on their achievements. Of course, some managers may take into account such a hidden contribution when evaluating team mates, but it is still hard to evaluate such a contribution quantitatively. It can be done with the described embodiments.

From the company perspective, employees are generally expected to work efficiently. For example, the company (or people at manager-class positions) would not like employees (especially junior staff) to stack some issue and spend a couple of days struggling with it even though they could solve the issue within 30 mins if they could be advised by a senior employee sitting next to them. The described embodiments can encourage employees to ask for help from someone else because their saved hours are accumulated as an index of efficiency.

Individual wiki to resolve repetitive questions. As used herein, the term “wiki” refers to online/offline documents, FAQs, blogs, articles, etc.

The described platform may bring additional burdens to experts because they may have more chances to get interrupted by others. It may not be a good idea to interrupt experts often even if collaborations among employees are productive and preferable from a macro perspective, because more interruptions may demotivate experts and cause them to leave the company in the worst case. Therefore, a function to minimize the number of repetitive questions is essential for the platform.

Conventional solutions often use a centralized wiki such as Confluence developed by Atlassian, but information on such systems tends to be obsolete. This can be explained by the fact that creating/editing an article on a centralized wiki often requires an internal review process creating a sense of accountability within the team or organization. This is a burden for experts and discourages them from putting out new information. According to some embodiments, to lessen the burden without sacrificing its benefit, an individual wiki for each expert is configured. Since it only belongs to one person and is not authorized by a team or organization, the burden for putting out new information is much smaller. Also, since experts can control the scope of wiki based on their skills, it is much easier to maintain, and enables advice seekers to easily find out if their question was answered in the past by the expert. As a result, experts can reduce the number of repetitive questions with minimum maintenance cost.

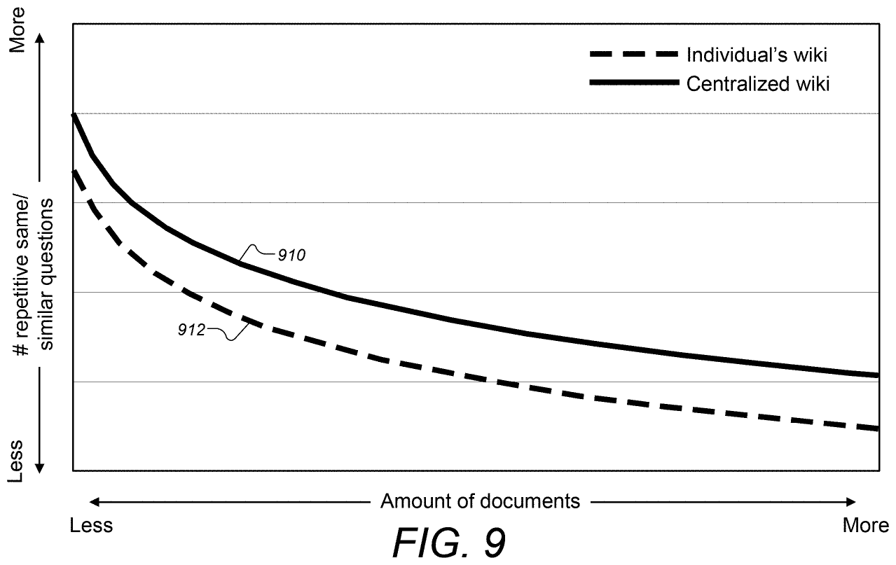

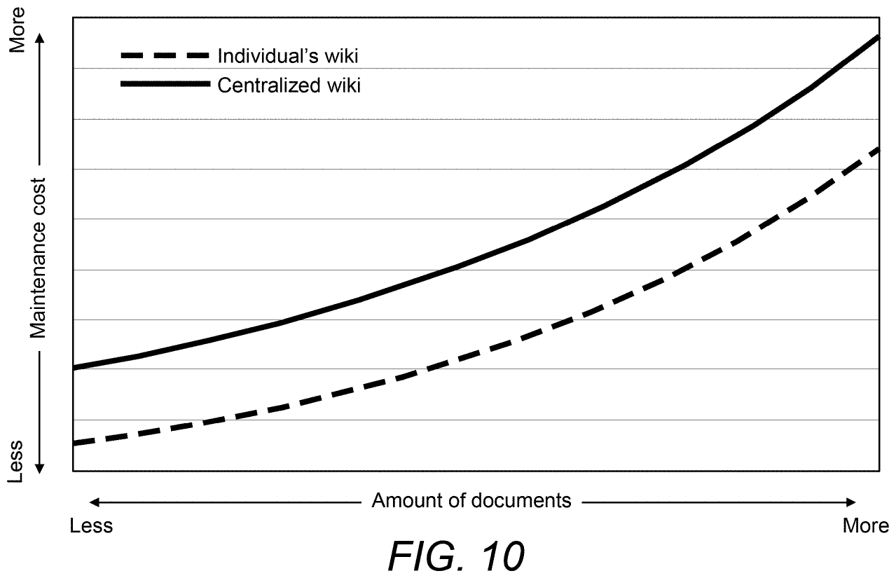

FIGS. 9 and 10 are plots illustrating reduction of repetitive questions and maintenance costs due to an individual wiki, according to some embodiments. FIGS. 9 and 10 are intended to reflect concepts rather than some experimental results. As the solid line of FIG. 9 shows, as the amount of information on centralized wiki increases, experts face less repetitive questions. However, the increase of information on centralized wiki can cause the maintenance cost to go up as experts need to spend time going through internal review and make sure it's accurate and up-to-date as shown in the solid line of FIG. 10.

The centralized wiki often has issues as a fundamental solution and can result in a zero-sum game where the growth of information on wiki actually increases the maintenance cost while reducing repetitive questions for experts. However, the individual wiki can drop below the solid line in FIG. 10 because the scope of individual wiki is clearer and easier to maintain than centralized wiki. See the dashed line in FIG. 10. The individual wiki can also drop below the solid curve in FIG. 9 because advice seekers can find answer to their repetitive questions more easily. See the dashed line in FIG. 9.

Private user preferences. Some experts may not like to be interrupted by others for many reasons. In such a case, according to some embodiments, a user may configure his attributes indicating his preference regarding collaboration. One example of the attributes is “Customer Facing”, which may take binary values and is set to true by default. If he doesn't have or doesn't like to help customer facing roles, he may set it to false and it may be reflected in search results for example.

According to some embodiments, other users cannot see these attributes because these may mislead an impression of his presence/contribution. Other user attributes such as a location, title, etc., are visible to all other users.

The following attributes may be configured for example, and these may be per-user and/or per-skill. (1) Open to customer-related questions (if false, the user may not appear in search results from sales person). (2) Welcome to explain technical details (if false, the user may not appear in search results from engineer). (3) Temporarily busy (if false, the user may not appear in search results). (4) Preferable time slots (the user may only appear in particular time slots). (5) Preferable advice seeker's background (the user may only appear in search results from users who meet the required skills). Some experts may expect advice seekers to have minimum requisites. For example, this expert doesn't like to explain about machine learning to anyone who doesn't have any experience.

Every employee has their own workstyle. The platform supports various engagement preferences to adapt to different workstyles, so employees can continue to work on their style and no friction or stress is caused by the platform.

Limitation of use. Some managers may not be comfortable that their staff spend a lot of time helping others working in different teams. It may happen especially when his team is under pressure to meet a deadline. In such a case, according to some embodiments, managers may configure a limit to staff's time spent on helping others. The spent time may be derived from collaboration histories and once the total spent time reaches to the limit, an indication may appear on the screen and/or the search engine may show such experts around the end of list (lower priority). According to some embodiments, managers may configure staff's attributes which limit the number of advice seeking outside their team so they don't bother other teams. The number may be derived from collaboration histories, and/or logs of searches, etc.

The following attributes may be configured in the platform for example, and these may be per-team and/or per-user: (1) maximum spent time in specific period; (2) maximum number of searches in specific period; (3) maximum number of collaborations in specific period; (4) do not appear in search result (true or false); and (5) maximum number and/or time of use of built-in video/audio chat system.

There may be teams with unique/different cultural backgrounds or unspoken/unwritten rules in the organization and the proposal in this section reduces friction among teams/individuals.

Platform for Macro Learning. Generally, learning can be divided into two major types, micro-learning and macro-learning. According to some embodiments, a series of typical actions (searching experts and getting advice from the found expert(s)) with the described platform may be categorized into micro-learning, because it solves issues immediately, and users can gain small but new pieces of knowledge in the short term.

According to some embodiments, the platform may contain or integrate into the function/platform which provides macro-learning, which takes a long time to gain benefits but raises an average baseline of users' skills.

According to some embodiments, users may post learning contents they recommend and these contents may be associated with skill data stored in the platform. Here, learning contents may include books, ebooks, online/offline documents, wiki, blogs, articles, videos, webinars, seminars, schools, courses, magazines, and academic papers, etc. Users may add some attributes such as estimated time to finish, recommended section, etc. to the registered learning contents.

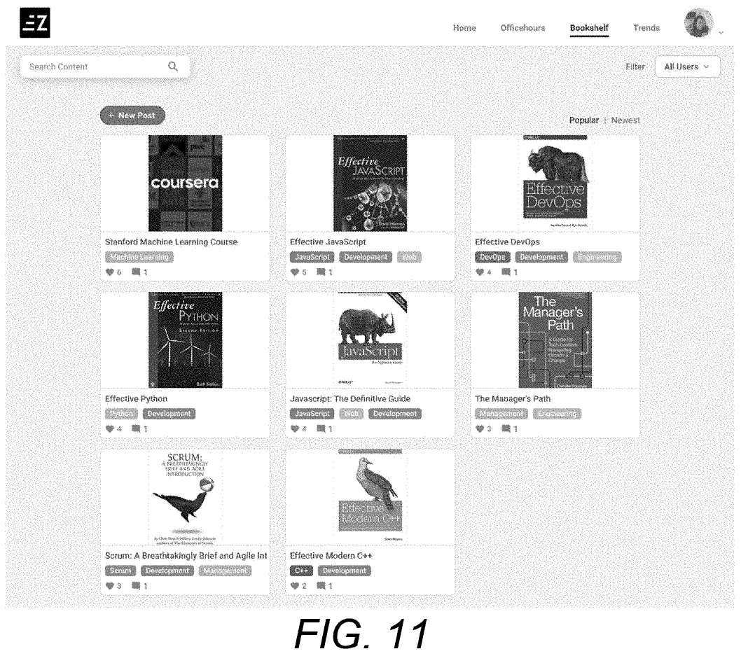

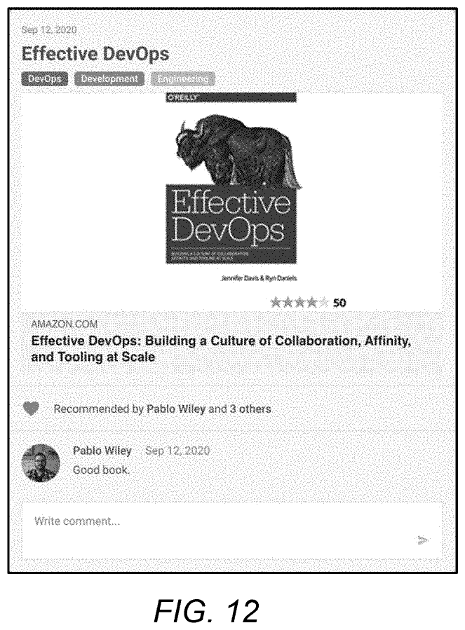

FIGS. 11 and 12 are graphical user interface of learning content recommended by other users, according to some embodiments. FIG. 11 shows an example of learning content in a graphical user interface, and FIG. 12 shows an example of a single content item being displayed. This function/platform for macro learning significantly improves the experience of finding learning content that is best fit for a user compared to public reviews such as Amazon review thanks to the following factors: (1) users can share contents recommended by known experts, rather than random unknown people; (2) users can know recommended contents based on the shared context of business of the company; and (3) users can share contents, assuming a baseline of skills.

Also, data of the learning contents associated with skill data may be utilized to recommend learning contents to some users who're developing/missing the skills. The recommendation may be done manually and/or by the recommendation system running on the platform.

Estimated Available Time Slots. According to some embodiments, the platform is configured to indicate estimated available time slots of found experts even if they're not available at that moment. For example, the platform can be configured to display all of the estimated available time slots, or only the first time slot among ones which don't overlap the advice seeker's schedule.

The platform can be configured to actively find and estimate available time slots of experts and lets the user know them with a notification. This is done by integrating 3rd party calendar application/services with the platform. The platform itself may have a calendar function and multiple calendars may be merged. The integration may require authentication and authorization through protocols such as OAuth.

The platform imports users' schedules registered in their calendars and estimates available time slots with the consideration of the following property. (1) Takes a time slot right after the first unavailable time slot. It assumes that it's more preferable to interrupt people not in the middle of their work. For example, it's more comfortable to be interrupted and asked a question right after a regular meeting than being interrupted while they're concentrating on their tasks (e.g. writing a document). (2) Takes a time slot N mins (eg. N=30) before the unavailable time slot. It also assumes that it's more preferable to interrupt people not in the middle of their work, and also assumes that people will not concentrate on their task 30 mins ahead of the schedule. (3) If not found in 1˜3, iterate 1˜3 for the next available time slots. Search ends until M more days (eg. M=3) are checked.

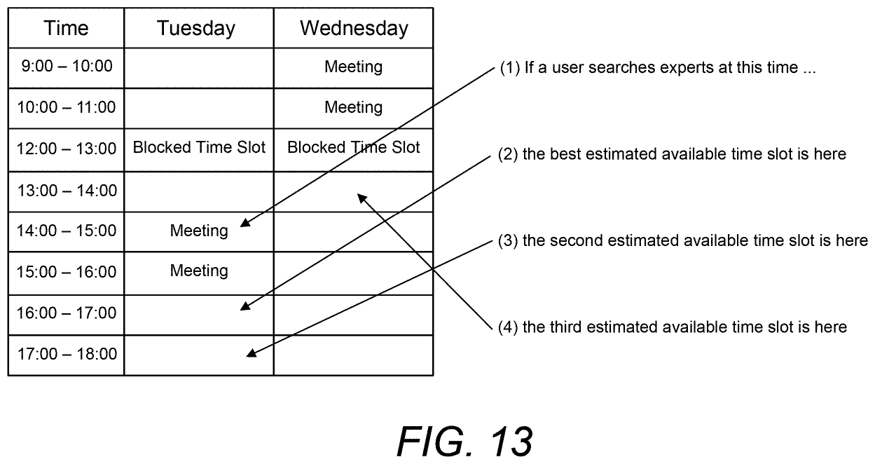

Here, users may configure time slots which are never available. FIG. 13 is a diagram illustrating an example of estimating available time slots with an integrated calendar, according to some embodiments. Existing solutions can import calendars managed by other services and merge multiple calendars, but do not actively estimate available time slots of users. Considering a search of experts, advice seekers have no idea about who will be found, so need to manually select and import experts' calendars and find available time slots (assuming that generally users share their calendars with others).

The described embodiment drastically saves advice seekers' time to find experts' available time slots and also experts have less chances of being interrupted unexpectedly. The platform reduces friction for building and sustaining mutual support among employees.

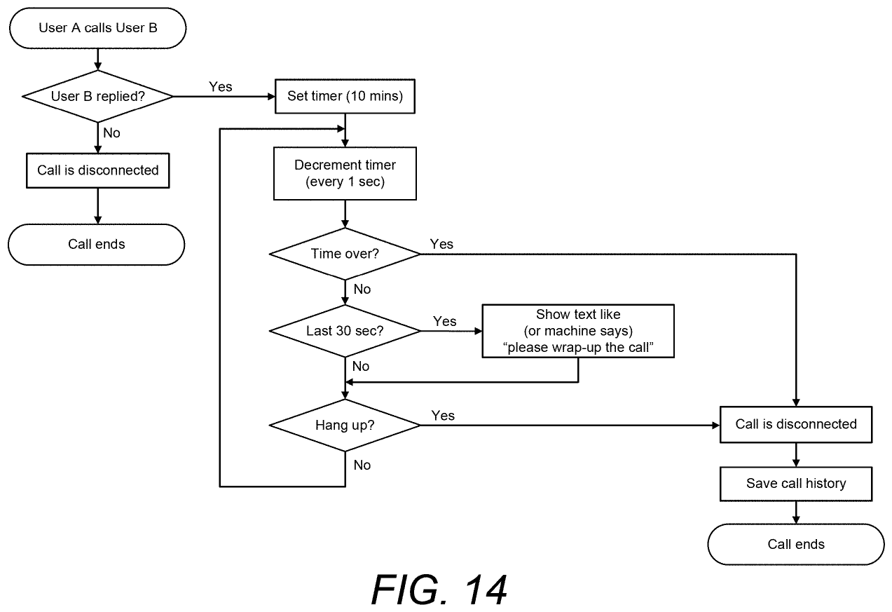

Audio/Video Chat Optimal for a Short Conversation. FIG. 14 is a block diagram illustrating built-in video/audio chat functionality, according to some embodiments. A shown, users can remotely communicate with others by the built-in audio/video chat. The built-in audio/video chat can be time-limited, that is, users can not have a conversation longer than 10 mins (this may be configured admin user). While having a remote conversation, a remaining time may be indicated, and also, a machine voice or text indicator may encourage users to wrap up the conversation 30 seconds (this may be configured admin user) ahead of the time limit.

After the conversation, users may be encouraged not to do follow-up to each other to save time. This is done by machine voice played right after the call, or text on screen, etc., that is, done by the platform.

If a user calls another person/people and he/they missed the call, the missed incoming call history does not remain in his/their side not to let him/her/them call back and not to let the user follow-up the missed call.

According to some embodiments, the built-in audio/video chat function is provided for short verbal communication, but users are not forced to use it for any remote communication tools (even for the short verbal communication). They can use any kind of remote communication tools, such as Zoom, Skype, Microsoft Teams, Phone, or Slack, etc.

The demand for short 1-on-1 meetings is increasing. The built-in audio/video chat is very efficient for the short verbal communication compared with the existing communication tools, such as Zoom, Skype, Microsoft Teams, Phone, or Slack, etc. Following are some characteristics, according to some embodiments, include one or more of the following. (1) Strictly Time-limited. If people have scheduled 1 hour slot for the meeting, people sometimes try to last the conversation until 1 hour has passed. The time-limit reduces such a chance. (2) Facilitated Wrap-up. Wrapping up the conversation is sometimes awkward, especially when the junior staff is talking with some senior staff. Since the machine/system facilitates wrap-up so users can smoothly end any conversations. (3) Not scheduled and no missed incoming call history. Scheduling is painful and takes a lot of time. The platform encourages users to talk to people who are available at that moment, so the built-in audio/video chat can start without scheduling. Since missed incoming call history isn't shown to users, users don't hesitate to call anyone and no need to follow-up even if the call is missed (For example, no need to text the person like “I've asked someone else and my issue was solved. So you don't need to call me back. Thank you!”). (4) Indicator not to do follow-up, Following up the conversation is very typical, such as text of “Thank you for answering my question” from the person who asked a question, or “You're welcome, if something is unclear, let me know.” from the person who answered the question. This is actually a “side effect” of remote communication. Imagine that you ask a question to the person sitting next to you in the office. You could solve an issue and quickly thank the person and that's it. However, people tend to thank the person verbally in the call and additionally do the follow-up the call in case of remote communication. The indicator has people notice these follow-ups are redundant and save time for time.

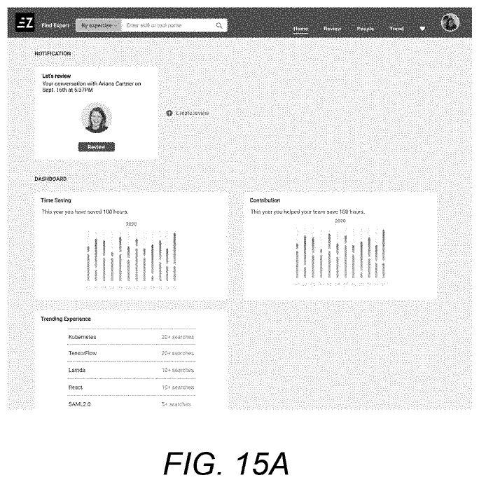

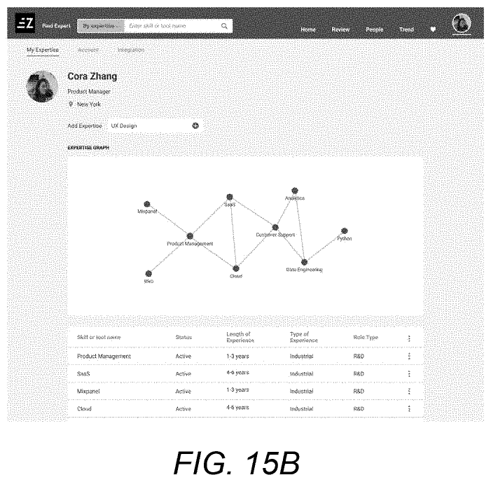

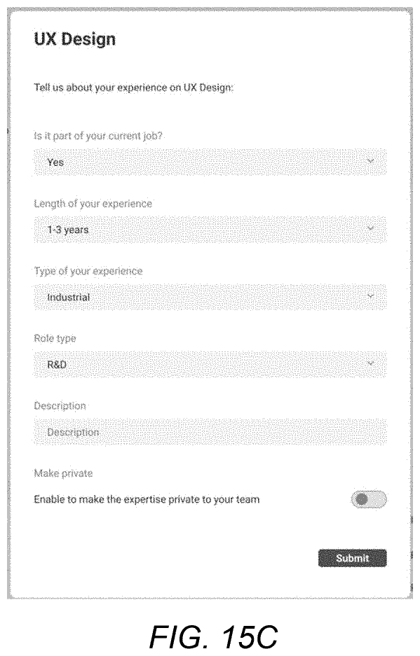

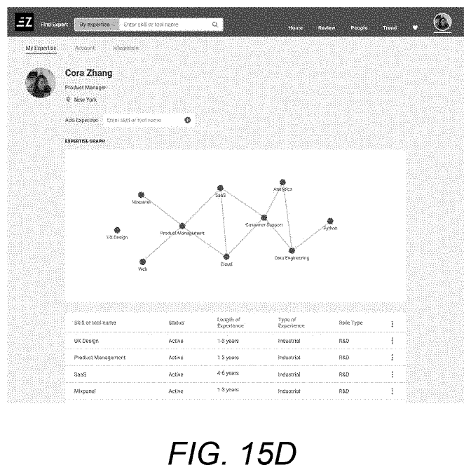

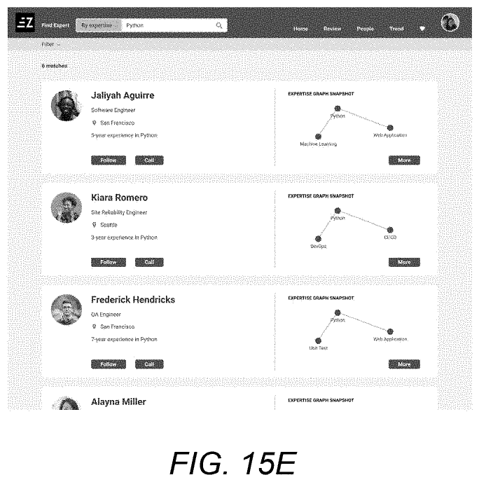

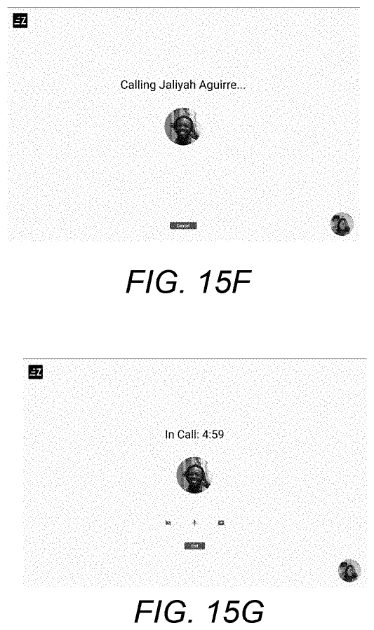

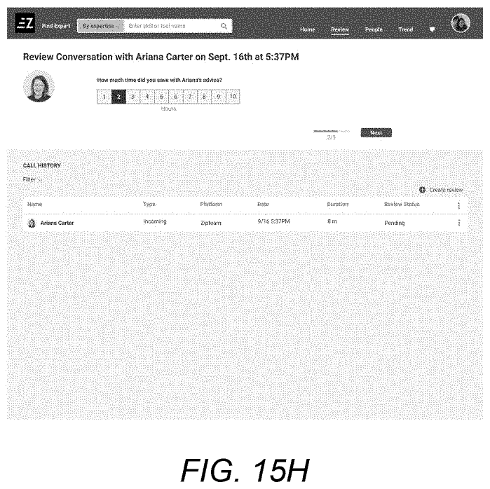

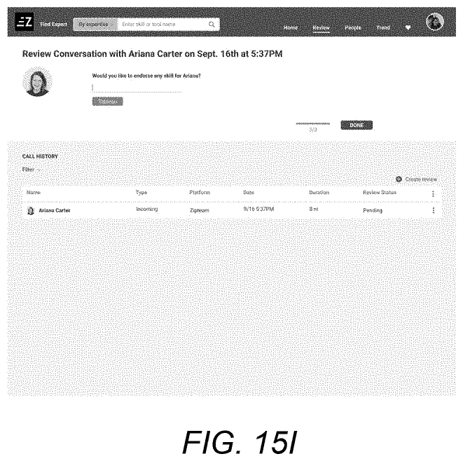

According to some embodiments, a use example of a software service which provides the platform is described. FIGS. 15A-15I are examples of a screens from a graphical user interface for a platform for skill data management, according to some embodiments. The name of the service is “Zipteam”. It is a SaaS (Software As A Service) product.

Workflow. As an example, a user encounters a technical question regarding Python (programming language) implementation of some AI algorithm. The user signs in the web page and firstly sees a dashboard page, which contains selected important functions of the service. FIG. 15A shows a “dashboard” interface. If it's the first time for her to sign in, she may edit her own skill data. It will be done graphically. In this example, she registered her skills manually, and didn't use the function to extract skills from her resume. FIG. 15B shows an example page for editing skill data. FIG. 15C shows an example of in interface for adding a skill. FIG. 15C shows an example of updated skill data. Since she doesn't know anyone who is familiar with both Python and AI in the same company except for herself, she searches experts by the skill names. Here, she inputs “Python”. She could successfully find experts working in the same company. She looks through the skill graph of each expert from top of the list, until she finds a preferable expert. Skill graphs are useful to grasp the skill set of each expert and the found experts are well-sorted, so she could find such an expert quickly. FIG. 15E shows an example selecting an expert with the consideration of the skill graphs. She calls the expert by the built-in video/audio chat system shown in FIG. 15E. She could schedule the conference call with the expert, but let's assume that she calls immediately in this example.

The user calls the expert by the built-in video/audio chat system shown in FIG. 15E. She could schedule the conference call with the expert, but let's assume that she calls immediately in this example. FIG. 15F shows a screen while attempting to call the expert with the built-in audio/video chat. She and the experts have a verbal chat as shown in FIG. 15G. Since the time is strictly limited (up to 10 mins), the expert is not worried about how long it may last. 30 seconds ahead of the time limit, both hear a machine voice encouraging them to wrap-up. Their communication smoothly ends.

Once the communication ends, she rates how many hours she could save by the expert's advice. More attributes to rate may be possible, but she only input the saved hours in this example. FIG. 15H shows rating of the saved hours. FIG. 15I shows an endorsement of skill. The expert also may rate his spent time. This time, the expert didn't need to spend time investigating any technical tips before/after the communication, so the expert simply input the duration of the chat on the page similar to FIG. 15G.

Once the rating is done, “Time Saving” and “Contribution” in the dashboard (see FIG. 15A) are updated immediately. Both work as an index of their work efficiency and contribution to the company. These indices can be used for employee performance review or recognition programs.

According to some embodiments, the platform includes the following components. (1) Search engine with recommendation algorithm to search experts. This enables users to search others by skill name(s) and find proper experts easily. It provides day-to-day benefit with users and encourages users to maintain/update their skill data. (2) Platform to rate advisors, report hidden contributions, and endorse skills for other users. This provides a mechanism to keep/drive mutual help among users. (3) Function to evaluate work efficiency and advisor's help quantitatively. This visualizes users' contributions and work efficiencies and makes evaluation of employees more accurate. (4) Estimation of available time slots. This saves users time by actively finding estimated available time of experts the user would like to talk to. (5) Audio/Video chat optimal for a short and verbal conversation. This saves users time by removing unnecessarily redundant communication and reduces a psychological/mental burden and/or pressure of verbal communication.

Skill data is one of the key data to solve people matters from a productivity perspective, but hard to maintain and update because it requires a bottom-up approach to do well, that is, each employees need to keep updating and brushing up their skill data, and skill data should be able to be aggregated/merged (and clustered), and finally skill data could get to be analyzable in an organization scale. The proposed platform brings an ecosystem to encourage employees to do so in a sustainable way with minimum stresses and day-to-day benefits to them.

It should be noted that there are many alternative ways of implementing both the processes and apparatuses described herein. Accordingly, the present embodiments are to be considered as illustrative and not restrictive, and the body of work described herein is not to be limited to the details given herein, which may be modified within the scope and equivalents of the appended claims.

What it claimed is:

1. A method of bottom-up building and operating a computer-implemented platform that speeds up network operation and reduces data storage requirements, comprising:
providing computer-stored skill data of experts as graphs that comprise nodes and edges related to respective skills and relationships of skills that reduce redundancy in skill identities and thereby reduce data storage requirements compared with tree structures of skill identities;
in response to a network-transmitted inquiry from a user seeking expert advice regarding a skill set, carrying out computer-implemented, content-based and other filtering of said graphs and/or of skill maps related to the graphs to thereby identify a set of experts fitting the inquiry;
establishing network communication between the user and an expert selected from said set of experts;
computer-limiting said communication in duration and in timing based on factors including data stored in the platform regarding limitations on times and duration associated with the selected expert and concluding the communication according to said duration limitations, thereby reducing network load and speeding up network operation compared to operation without said limitations;
computer-tracking and storing parameters of the communication including whether an issue associated with the inquiry was resolved, time-savings to the user associated with or resulting from the communication, and time investment by the expert in the communication and computer-quantifying and storing parameters related to benefits from communications between users and experts and time of experts related to the communications; and
providing users with networked access to pre-stored answers by experts associated with respective experts and respective skill identities contained in said graphs of nodes and edges to thereby reduce network traffic and computer usage due to reduction of requests for direct communications with experts.

2. The method of claim 1, in which said providing of skill data of experts as graphs is configured for dynamic bottom-up updating of said graphs by adding or deleting skill identities and/or experts based at least in part to said communications between users and experts.

3. The method of claim 1, in which said filtering includes initial filtering by skill identity rather than identity of experts.

4. The method of claim 1, in which said computer-tracking and storing parameters comprises associating rewards to experts based at least in part to the nature and extent of their participation in said communications with users to thereby encourage experts to participate in providing advice to users.

5. The method of claim 1, in which said computer-limiting of communication in duration and timing comprises limiting a communication between a user and an expert to a time slot less than one hour, automatically announcing that the time slot is about to expire, and automatically terminating the communication at the expiration of the time slot, thereby reducing network load by precluding non-essential extension of communications.

6. The method of claim 1, in which said providing of access to pre-stored answers by experts comprises associating individual experts with respective sets of said pre-stored answers.

7. The method of claim 1, in which said providing of access to pre-stored answers by experts comprises associating individual skill identities with respective sets of said pre-stored answers.

8. The method of claim 1, in which said graphs comprise nodes associated with respective skills that are identified by name as well as aliases and abbreviations thereof without duplication of names, aliases or abbreviations, thereby reducing memory requirements for storing identities of skills compared with storing tree structures of skill identities, while facilitating search for skills identified by an alias of an abbreviation of a skill name.

9. The method of claim 1, in which said filtering includes computer-implemented dynamic rating of experts based on past user-expert communications.

10. A method of bottom-up, computer-implemented operation of a system for providing expert advice to users, comprising:
computer-storing skill data as graphs that comprise nodes and edges related to respective sets of related skills and relationships of the skills using less data storage compared with tree structures of the skills and relationships;
transmitting via a network a request from a user for expert advice regarding a skill or a skill set;
computer-processing the request based at least in part of said skill data stored as said graphs of nodes and edges to filter said graphs and thereby select a skill or a skill set that fits the request;
further computer-implemented filtering to select an expert associated with the selected skill or skill sets based on parameters including expert availability and past interactions of experts and users;
establishing network communication between the user and the selected expert;
computer-limiting said communication in duration and limiting timing of the communication, thereby reducing network load and speeding up network operation compared to network operation without said limitations;
computer-tracking and storing assessment data related to the communication including whether and how the request was resolved, time-savings to the user associated with or resulting from the communication, and time spent by the expert in the communication, and storing data regarding assessments of and benefits from communications between users and experts and time spent by experts related to the communications;
providing users with networked access to pre-stored answers by experts associated with respective experts and respective skill identities contained in said graphs of nodes and edges to thereby reduce network traffic and computer usage due to reduction of requests for and direct communications with experts.

11. The method of claim 10, in which said providing of skill data of experts as graphs comprises dynamic bottom-up updating of said graphs by adding or deleting skill and/or expert identities based at least in part on said communications between users and experts.

12. The method of claim 10, in which said filtering includes initial filtering by skill identity rather than identity of experts.

13. The method of claim 10, in which said computer-tracking comprises associating rewards to experts based at least in part to the nature and extent of their participation in communications with users to thereby encourage experts to participate in providing advice to users.

14. The method of claim 10, in which said computer-limiting of communication in duration and timing comprises limiting a communication between a user and an expert to a time slot less than one-half hour, automatically announcing that the time slot is about to expire, and automatically terminating the communication at the expiration of the time slot, thereby reducing network load by precluding non-essential extension of communications.

15. The method of claim 10, in which said graphs comprise nodes associated with respective skills that are identified by name as well as aliases and abbreviations thereof without duplication of names, aliases or abbreviations, thereby reducing memory requirements for storing identities of skills compared with storing tree structures of skill identities, while facilitating search for skills identified by an alias of an abbreviation of a skill name.

16. The method of claim 10, in which said filtering includes computer-implemented dynamic rating of experts based on past user-expert communications.

17. A system for bottom-up, computer-implemented provision of expert advice to users, comprising:
a computer-implemented facility storing skill data as graphs of nodes and edges related to respective sets of related skills and relationships of the skills, thereby reducing data storage computer memory requirements compared with storing tree structures of the skills and relationships;
a skill-selecting, computer-implemented search and filtering facility configured to respond to user requests for expert advice by selecting respective skills or skill sets in said graphs fitting the respective requests;
a user-selecting, computer-implemented facility configured to select respective experts associated with the respective selected skills or skill sets based on expert availability and user inputs related to past requests for expert advice;
computer-processing the request based at least in part of said skill data stored as said graphs of nodes and edges to filter said graphs and thereby select a skill or a skill set that fits the request;
further computer-implemented filtering to select an expert associated with the selected skill or skill sets based on parameters including pre-stored data regarding expert availability and past interactions of experts and users;
a network facility configured to provide communication between users and selected experts related to said requests;
a communication-limiting facility configured to computer-limit said communications in duration and in timing of the communications, thereby reducing network load and speeding up network operation compared to network operation without said limitations;
a tracking facility configured to computer-track said user-expert communication and extract and store assessments related thereto including regarding resolutions of the requests, time-savings to the users associated with or resulting from the communications, and time spent by the experts in the communications, and storing data regarding assessments of and benefits from said communications and time spent by experts related to the communications; and
a networked access facility providing users with pre-stored answers by experts associated with respective experts and respective skills identified in said graphs of nodes and edges to thereby reduce network traffic and computer usage due to reduction of requests for and direct communications with experts.

18. The system of claim 17, further including a dynamic bottom-up updating of said graphs by adding or deleting skill and/or expert identities based at least in part on said communications between users and experts.

19. The system of claim 17, further including a reward facility configured to track said communications and to assign rewards to experts based at least in part to the nature and extent of their participation in said communications with users to thereby encourage experts to participate in advising users.

20. The system of claim 17, in which said computer-implemented facility storing skill data as graphs of nodes and edges stores nodes associated with respective skills that are identified by name as well as aliases and abbreviations thereof without duplication of names, aliases or abbreviations, thereby reducing memory requirements compared with storing tree structures of skill identities, while facilitating search for skills identified by an alias of an abbreviation of a skill name.
